(19) United States
(12) Patent Application Publication
(10) Pub. No.: US 2014/0347283 A1
(43) Pub. Date: Nov. 27, 2014

(54) HAPTIC FEEDBACK ACTUATOR MODULE AND ELECTRONIC DEVICE INCLUDING THE SAME

(71) Applicant: SAMSUNG ELECTRO-MECHANICS CO., LTD., Suwon (KR)

(72) Inventors: Boum Seock Kim, Suwon (KR); Jung Wook Seo, Suwon (KR)

(73) Assignee: SAMSUNG ELECTRO-MECHANICS CO., LTD., Suwon (KR)

(21) Appl. No.: 13/959,979

(22) Filed: Aug. 6, 2013

(30) Foreign Application Priority Data
May 27, 2013 (KR) 10-2013-0059666

(51) Int. Cl. G06F 3/01

(52) U.S. Cl. CPC G06F 3/016
USPC 345/173

(57) ABSTRACT

There is provided a haptic feedback actuator module including: a base member including an insertion groove formed in an edge thereof and communications grooves formed at both ends of the insertion groove; a piezoelectric element inserted into the insertion groove; an impact transferring member installed in the communications groove and contacting a display panel or spaced apart from the display panel during deformation of the piezoelectric element; and a connecting member having one end connected to the piezoelectric element and the other end connected to the impact transferring member.

### CROSS-REFERENCE TO RELATED APPLICATIONS

This application claims the priority of Korean Patent Application No. 10-2013-0059666 filed on May 27, 2013, in the Korean Intellectual Property Office, the disclosure of which is incorporated herein by reference.

### BACKGROUND OF THE INVENTION

1. Field of the Invention

The present invention relates to a haptic feedback actuator module and an electronic device including the same.

2. Description of the Related Art

In accordance with recent user demand for electronic devices which are simple to use, a touchscreen type device, allowing data to be input thereto through a screen of an electronic device being touched has been introduced.

Currently, a haptic feedback device includes the concept of reflecting intuitive user experience in an interface, and further diversifying touch feedback, in addition to the concept data input being performed through a screen of an electronic device being touched.

Here, such a haptic feedback device has various advantages such as compatibility with a range of information technology (IT) devices, in addition to space savings, improved operability, simplicity, ease in upgrading installed software, and high user recognition.

Due to these advantages, the haptic feedback device has been widely utilized in electronic devices used in the fields of computing, traffic, customer service devices, medicine, mobile devices, and the like.

Generally, in an electric device according to the related art, a vibration motor has been used in order to implement a haptic feedback function. Since the vibration motor is designed to vibrate the entire electronic device, it may have a problem in that a size of a mass body used therein should be increased in order to increase vibratory force.

The vibration motor as described above may have a problem in that it may be inefficient r in vibrating the entire electronic device in view of power consumption, as well as a problem that implementation thereof may lead to increased manufacturing costs and is limited to being disposed in a relatively restrictive internal space of an electronic device.

In addition, recently, as user interfaces have expanded and electronic device functions have become diversified and relatively complicated, the vibration motor for vibrating the entire electronic device has a difficulty in implementing various types of feedback, depending on various functions.

Therefore, recently, a piezoelectric scheme using a piezoelectric element to generate vibrations by converting an electrical signal into mechanical displacement has been used. In addition, since the piezoelectric scheme has a response speed which is several tens or several hundreds of times more rapid than that of an existing vibration motor, it has excellent characteristics in view of flexibility in a haptic operations and rapid touch recognition.

However, in the case of the piezoelectric scheme, since it is difficult to generate vibratory force by only applying an electrical signal, unlike in the case of a vibration motor, a module structure should be manufactured by using various methods. Therefore, it may be difficult to manufacture such a piezoelectric element while decreasing a size and a thickness of the piezoelectric element.

Further, since the piezoelectric element itself may be relatively expensive, it may be difficult to use many large piezoelectric elements, such that it may be inefficient in generating a large amount vibratory force when the cost thereof is taken into account.

Therefore, development of a technology for generating a high degree of vibratory force by using a small, thin piezoelectric material by optimizing the entire structure including a piezoelectric element for increasing vibratory force, as well as improving performance of the piezoelectric element itself, has been demanded.

That is, according to the related art, a piezoelectric element is fixed to a base member by an adhesive, such that vibrations are attenuated due to the adhesive. As a result, an amount of vibrations is decreased. Therefore, development of a technology of generating a high degree of vibratory force has been demanded.

### RELATED ART DOCUMENT

(Patent Document 1) Korea Patent Laid-Open Publication No. 2011-0075715

### SUMMARY OF THE INVENTION

An aspect of the present invention provides a haptic feedback actuator module capable of increasing an amount of vibrations, and an electronic device including the same.

According to an aspect of the present invention, there is provided a haptic feedback actuator module including: a base member including an insertion groove formed in an edge thereof and communications grooves formed at both ends of the insertion groove; a piezoelectric element inserted into the insertion groove; an impact transferring member installed in the communications groove and contacting a display panel or spaced apart from the display panel during deformation of the piezoelectric element; and a connecting member having one end connected to the piezoelectric element and the other end connected to the impact transferring member.

The impact transferring member may be rotatably installed on a shaft installed in the communications groove and rotated during the deformation of the piezoelectric element.

The impact transferring member may include a contact part contacting the display panel or spaced part from the display panel by rotation or an extension part extended from the contact part and connected to the connecting member.

The base member may be provided with a connection hole connecting the insertion groove and the communications groove to each other, and one end portion of the connecting member may be disposed in the communications groove while penetrating through the connection hole.

The haptic feedback actuator module may further include an elastic member stacked on an upper surface of the base member so as to be disposed above the communications groove.

The impact transferring member and the communicating groove may have inclined surfaces so that the impact transferring member is movable during the deformation of the piezoelectric element.

The connecting member may have one end connected to the piezoelectric element and the other end contacting the impact transferring member or disposed to be spaced apart from the impact transferring member by a predetermined interval to allow the impact transferring member to be moved along the inclined surface during deformation of the piezoelectric element.

The base member may be provided with a connection hole connecting the insertion groove and the communications groove to each other, and one end portion of the connecting member may be led to the communications groove while penetrating through the connection hole.

The connecting member may have a degree of strength capable of preventing the piezoelectric element from sagging when driving of the piezoelectric element ends.

According to another aspect of the present invention, there is provided an electronic device including: a case having an internal space formed therein; a display panel accommodated and disposed in the case; a base member installed in the case so as to be spaced apart from the display panel by a predetermined distance and including an insertion groove formed in an edge thereof and communications grooves formed at both ends of the insertion groove; a piezoelectric element inserted into the insertion groove; an impact transferring member installed in the communications groove and providing vibrations to the display panel during deformation of the piezoelectric element; and a connecting member having one end connected to the piezoelectric element and the other end connected to the impact transferring member.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic exploded perspective view illustrating an electronic device according to an embodiment of the present invention;

FIG. 2 is a schematic perspective view illustrating a case in which a haptic feedback actuator module is mounted on a case of the electronic device according to the embodiment of the present invention;

FIG. 3 is a schematic perspective view illustrating the haptic feedback actuator module according to the embodiment of the present invention;

FIG. 4 is a schematic configuration diagram illustrating the haptic feedback actuator module according to the embodiment of the present invention;

FIGS. 5 and 6 are views for describing an operation of the haptic feedback actuator module according to the embodiment of the present invention;

FIG. 7 is a schematic configuration diagram illustrating a haptic feedback actuator module according to another embodiment of the present invention; and

FIGS. 8 and 9 are views for describing an operation of the haptic feedback actuator module according to another embodiment of the present invention.

### DETAILED DESCRIPTION OF THE EMBODIMENTS

Hereinafter, embodiments of the present invention will be described in detail (with reference to the accompanying drawings). The invention may, however, be embodied in many different forms and should not be construed as being limited to the embodiments set forth herein. Rather, these embodiments are provided so that this disclosure will be thorough and complete, and will fully convey the scope of the invention to those skilled in the art. (In the drawings, the shapes and dimensions of elements may be exaggerated for clarity, and the same reference numerals will be used throughout to designate the same or like elements.

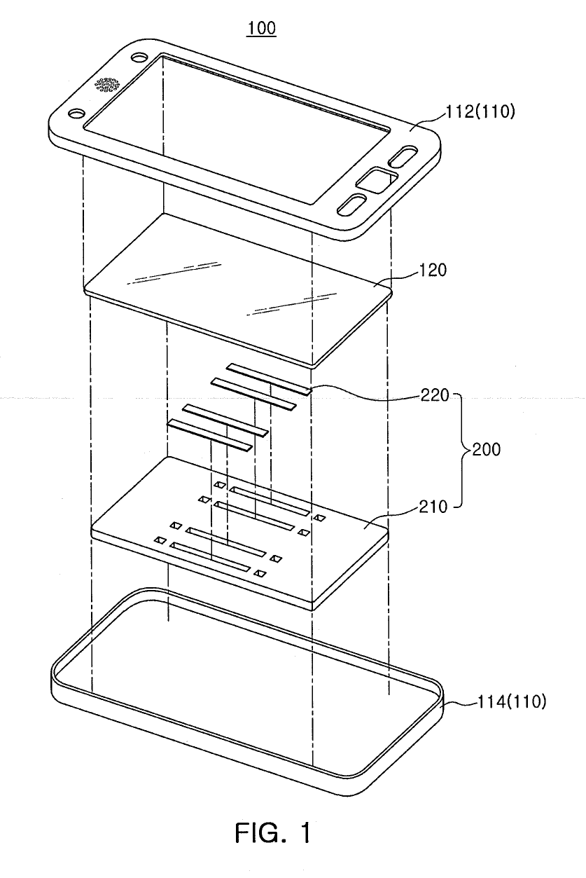

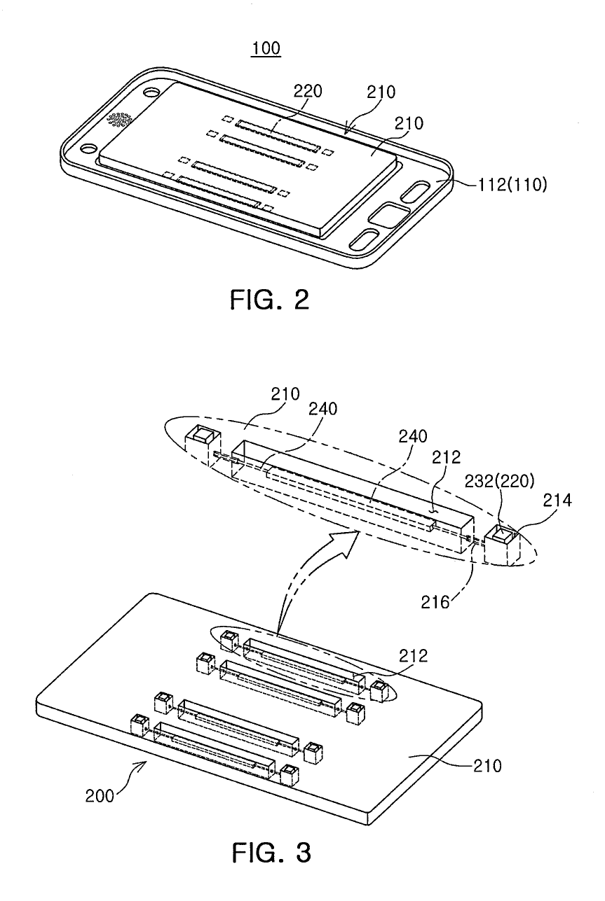

FIG. 1 is a schematic exploded perspective view illustrating an electronic device according to an embodiment of the present invention; FIG. 2 is a schematic perspective view illustrating a case in which a haptic feedback actuator module is mounted on a case of the electronic device according to the embodiment of the present invention; and FIG. 3 is a schematic perspective view illustrating the haptic feedback actuator module according to the embodiment of the present invention.

Referring to FIGS. 1 through 3, the electronic device 100 according to the embodiment of the present invention may include a case 110, a display panel 120, and a haptic feedback actuator module 200 by way of example.

Meanwhile, the electronic device 100 according to the embodiment of the present invention may be a mobile communications terminal. However, the electronic device 100 is not limited thereto, and haptic devices in which a change is vibrations is generated depending on user contact, such as various office automation (OA) devices, medical devices, mobile communications devices, ticket issuing devices, and the like.

The case 110 may have an internal space. Meanwhile, the case 110 may include a front case 112 and a rear case 114. That is, the front case 112 and the rear case 114 are coupled to each other, such that the internal space may be formed.

Meanwhile, the internal space of the case 110 described above may have the display panel 120 and a circuit board (not shown) for driving the haptic feedback actuator module 200 mounted thereon.

In addition, the display panel 120, the haptic feedback actuator module 200, and the circuit board may configure the haptic device, which indicates a mechanism requiring vibrations.

Further, the haptic device may be an internal component of a mobile communications terminal, an electronic device requiring a reaction depending on a contact from the outside.

The haptic device may be a data input device, an office Automation (OA) device, a vending machine, a bed, a card, an operating device, a ticket vending machine, or the like, requiring vibrations depending on a contact, according to embodiments, as well as a mobile communications terminal.

The display panel 120 may be accommodated and disposed in the case 110. Meanwhile, the display panel 120 may be installed in the case 110 so as to be exposed to an opening 112a of the case 110 so that it may be touched by the user.

Meanwhile, the display panel 120 may serve to provide an image and may perform a haptic reaction, that is, vibrations in the case in which the user touches the display panel 120.

To this end, the display panel 120 may vibrate through the above-mentioned haptic feedback actuator module 200.

A specific vibration generation principle of the haptic feedback actuator module 200 for vibrations of the display panel 120 will be described below.

The haptic feedback actuator module 200 may generate vibrations in the case in which the user touches the display panel 120 and be accommodated and disposed in the above-mentioned case 110. That is, the haptic feedback actuator module 200 may be installed in the case 110 so as to be disposed below the display panel 120.

Hereinafter, the haptic feedback actuator module according to the embodiment of the present invention will be described in more detail with reference to the accompanying drawings.

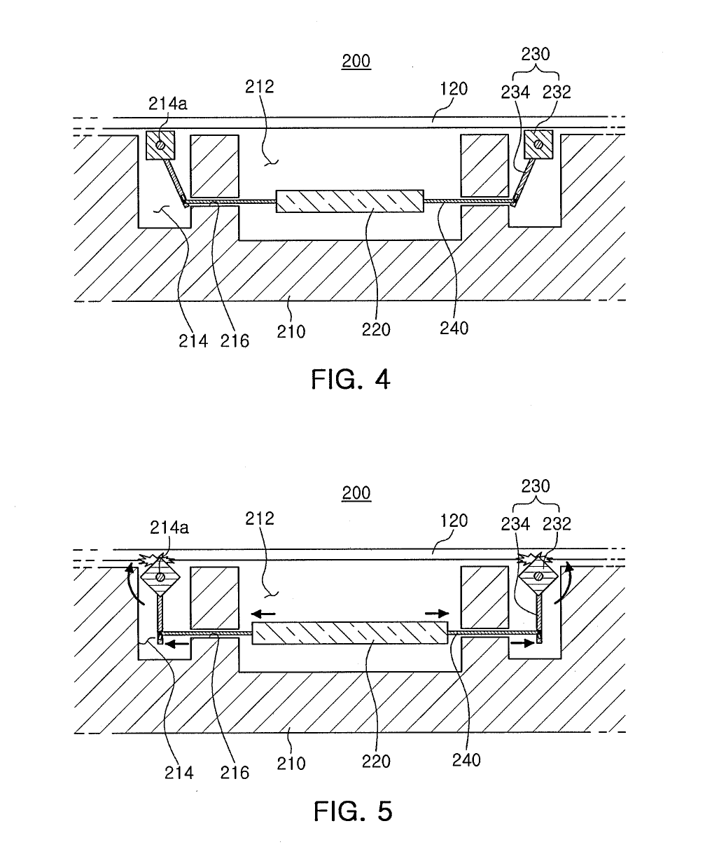

FIG. 4 is a schematic configuration diagram illustrating the haptic feedback actuator module according to the embodiment of the present invention.

Referring to FIG. 4, the haptic feedback actuator module 200 according to the embodiment of the present invention may include a base member 210, a piezoelectric element 220, an impact transferring member 230, and a connecting member 240.

The base member 210 may be fixedly attached to the above-mentioned case 110 (See FIG. 1). Meanwhile, the base member 210 may include insertion grooves 212 formed in an edge thereof, communications grooves 214 formed at both ends of the insertion grooves 212, and connection holes 216 connecting the insertion grooves 212 and the communications grooves 214 to each other.

Meanwhile, the insertion grooves 212 may be formed in a length direction (an ‘X’ direction of FIG. 1) of the base member 210 by way of example. In addition, the insertion grooves 212 may have a plurality of rows in a width direction (a ‘Y’ direction of FIG. 1) of the base member 210.

That is, the insertion grooves 212 may be disposed to be adjacent to at least two sides of the base member 210 and have two rows, such that they may be provided in a total of four rows.

However, the insertion grooves 212 are not limited thereto, but may also be formed on at least two sides of the base member 210 so as to have one row or three or more rows.

In addition, the insertion groove 212 may have a length and a width at which the piezoelectric element 220 may be inserted thereinto. In other words, the insertion groove 212 has a size larger than that of the piezoelectric element 220, such that the piezoelectric element 220 may be inserted into the insertion groove 212.

The communications grooves 214 may be formed at both ends of the insertion grooves 212, as described above. In addition, the communications groove 214 may have the impact transferring member 230 inserted thereinto and have a size larger than that of the impact transferring member 230 so as to prevent interference with the impact transferring member 230 during rotation of the impact transferring member 230.

Further, the communications groove 214 may have a shaft 214a installed therein so that the impact transferring member 230 is rotatable. A detailed description thereof will be provided below.

Meanwhile, the connection holes 216 may connect the insertion grooves 212 and the communications grooves 214 to each other. In addition, the connection hole 216 may have a length shorter than that of the connecting member 240.

The piezoelectric element 220 may be inserted into the insertion groove 212. That is, the piezoelectric element 220 may have both end portions fixedly attached to the connecting members 240 and be disposed in the insertion groove 212.

In addition, the piezoelectric element 220 may be expanded and contracted in a length direction of the insertion groove 212. Therefore, during deformation of the piezoelectric element 220, the connecting member 240 may be moved in the length direction depending on the deformation of the piezoelectric element 220.

The impact transferring member 230 may be installed in the communications groove 214 and contact the display panel 120 or be spaced apart from the display panel 120 during the deformation of the piezoelectric element 220. To this end, the impact transferring member 230 may include a contact part 232 contacting the display panel 120 or spaced part from the display panel 120 by rotation or an extension part 234 extended from the contact part 232 and having a distal end portion connected to the connecting member 240.

The contact part 232 may be installed on the shaft 214a installed in the above-mentioned communications groove 214 and be rotated during movement of the connecting member 240. Meanwhile, the contact part 232 may have a rectangular transversal cross section.

In addition, when driving of the piezoelectric element 220 ends, a lower surface of the display panel 120 and an upper surface of the contact part 232 may be disposed in parallel with each other, and when the piezoelectric element 220 is driven, the contact part 232 is rotated, such that an edge of the contact part 232 may contact the lower surface of the display panel 120.

As described above, when the piezoelectric element 220 is repeatedly expanded and contracted, the contact part 232 may repeatedly contact the display panel 120 and be spaced apart from the display panel 120 to allow the display panel 120 to vibrate.

Meanwhile, the extension part 234 may be extended from a lower end portion of the contact part 232 and have a bar shape. That is, the extension part 234 may be moved together with the connecting member 240 in the case in which the connecting member 240 moves, such that it may be rotated by a predetermined angle.

In addition, although not shown in detail in the accompanying drawings, the extension part 234 may also have an arc shaped hole formed at a distal end thereof in order to convert linear movement of the connecting member 240 into rotation of the extension part 234.

Further, the connecting member 240 may be connected to the extension part 234 so as to be moved along the hole formed at the distal end of the extension part 234.

The connecting member 240 may have one end connected to the piezoelectric element 220 and the other end connected to the impact transferring member 230. Meanwhile, the connecting member 240 may be disposed to penetrate through the connection hole 216 and be moved along the connection hole 216 while being moved.

In addition, the connecting member 240 has the other end connected to the hole formed at the distal end of the extension part 234 of the impact transferring member 230 through a pin, such that the linear movement of the connecting member 240 may be converted into the rotational movement of the extension part 234.

In addition, the connecting member 240 may be formed of a material strong enough to prevent the piezoelectric element 220 from sagging due to inherent weight of the piezoelectric element 220 in the case in which power is not supplied to the piezoelectric element 220. That is, the connecting member 240 may have strength capable of preventing the piezoelectric element 220 from sagging.

As described above, the impact transferring member 230 repeatedly contacts the display panel 120 and is spaced apart from the display panel 120 depending on the expansion and contraction of the piezoelectric element 220, whereby the display panel 120 may vibrate.

As a result, the connecting member 240 is moved by deformation of the piezoelectric element 220 such as the expansion and contraction of the piezoelectric element 220 to directly apply impact the display panel 120 through the impact transferring member 230, whereby attenuation of vibrations due to an adhesive formed of epoxy, or the like, may be prevented.

That is, in the case in which the piezoelectric element 220 is attached to the base member 210 by the adhesive, the attenuation of the vibrations due to the adhesive such as epoxy may be generated. However, as described above, the impact by the deformation of the piezoelectric element 220 may be transferred to the display panel 120 without the attenuation of the vibrations through the connecting member 240 and the impact transferring member 230, such that an amount of vibrations may increase.

Hereinafter, an operation of the haptic feedback actuator module according to the embodiment of the present invention will be described with reference to the accompanying drawings.

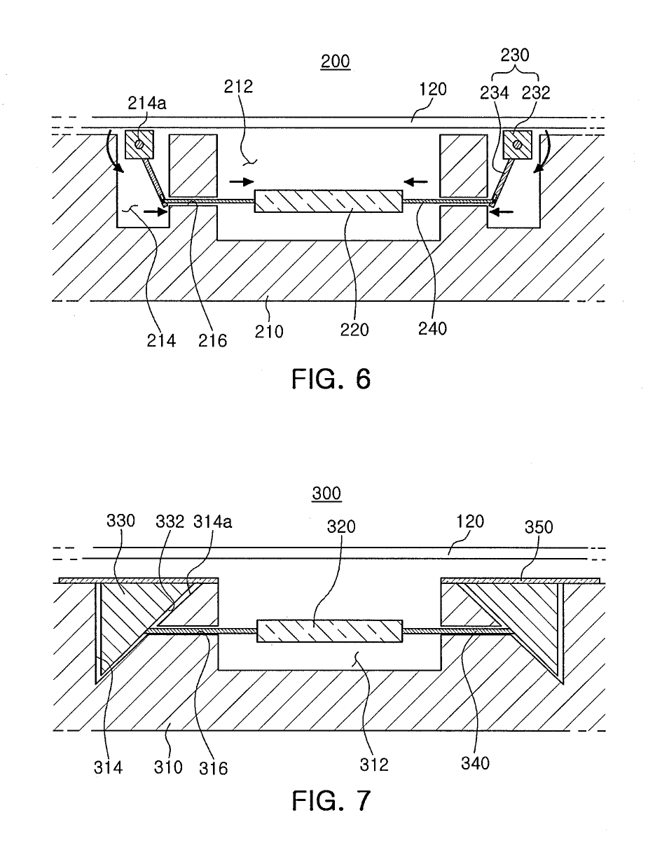

FIGS. 5 and 6 are views for describing an operation of the haptic feedback actuator module according to the embodiment of the present invention.

First, as shown in FIG. 5, when power is supplied to the piezoelectric element 220, the piezoelectric element 220 may be expanded. Therefore, the connecting member 240 having one end portion fixedly attached to the piezoelectric element 220 may be moved in a direction away from a side on which the piezoelectric element 220 is disposed.

In this case, the connecting member 240 may be moved along the connection hole 216 formed in the base member 210.

When the connecting member 240 is moved, the impact transferring member 230 may be rotated around the shaft 214a. Therefore, the contact part 232 of the impact transferring member 230 may contact the lower surface of the display panel 120 to apply impacts to the display panel 120.

Then, when the piezoelectric element 220 is contracted, the connecting member 240 may be moved from a side at which the communications groove 214 is disposed toward the piezoelectric element 220, as shown in FIG. 6. Therefore, the impact transferring member 230 may be rotated around the shaft 214a, and the contact part 232 of the impact transferring member 230 may be spaced apart from the display panel 120.

As described above, the impact transferring member 230 repeatedly contacts the display panel 120 and is spaced apart from the display panel 120 depending on the expansion and contraction of the piezoelectric element 220, whereby the display panel 120 may vibrate.

As a result, the connecting member 240 is moved by deformation of the piezoelectric element 220 such as the expansion and contraction of the piezoelectric element 220 to directly apply impacts to the display panel 120 through the impact transferring member 230, whereby attenuation of vibrations due to an adhesive formed of epoxy, or the like, may be prevented.

That is, in the case in which the piezoelectric element 220 is attached to the base member 210 by the adhesive, the attenuation of the vibrations due to the adhesive such as epoxy may be generated. However, as described above, the impact by the deformation of the piezoelectric element 220 may be transferred to the display panel 120 without the attenuation of the vibrations through the connecting member 240 and the impact transferring member 230, such that an amount of vibrations may increase.

Hereinafter, a haptic feedback actuator module according to another embodiment of the present invention will be described with reference to the accompanying drawings.

FIG. 7 is a schematic configuration diagram illustrating a haptic feedback actuator module according to another embodiment of the present invention.

Referring to FIG. 7, the haptic feedback actuator module 300 according to another embodiment of the present invention may include a base member 310, a piezoelectric element 320, an impact transferring member 330, a connecting member 340, and an elastic member 350.

The base member 310 may be fixedly attached to the above-mentioned case 110 (See FIG. 1). Meanwhile, the base member 310 may include insertion grooves 312 formed in an edge thereof, communications grooves 314 formed at both ends of the insertion grooves 312, and connection holes 316 connecting the insertion grooves 312 and the communications grooves 314 to each other.

Meanwhile, the insertion grooves 312 may be formed in a length direction (the ‘X’ direction of FIG. 1) of the base member 310 by way of example. In addition, the insertion grooves 312 may have a plurality of rows in a width direction (the ‘Y’ direction of FIG. 1) of the base member 310.

That is, the insertion grooves 312 may be disposed to be adjacent to at least two sides of the base member 310 and have two rows, such that they may be configured of a total of four rows.

However, the insertion grooves 312 are not limited thereto, but may also be formed on at least two sides of the base member 310 so as to be provided in an amount of one row or three or more rows.

In addition, the insertion groove 312 may have a length and a width at which the piezoelectric element 320 may be inserted thereinto. In other words, the insertion groove 312 has a size larger than that of the piezoelectric element 320, such that the piezoelectric element 320 may be inserted into the insertion groove 312.

The communications grooves 314 may be formed at both ends of the insertion grooves 312, as described above. In addition, the communications groove 314 may have an impact transferring member 330 inserted thereinto and include an inclined surface 314a so that the impact transferring member 330 is movable. In other words, an inner side wall forming the communications groove 314 may be inclined.

Meanwhile, the connection holes 316 may connect the insertion grooves 312 and the communications grooves 314 to each other. In addition, the connection hole 316 may have a length shorter than that of a connecting member 340.

The piezoelectric element 320 may be inserted into the insertion groove 312. That is, the piezoelectric element 320 may have both end portions fixedly attached to the connecting members 340 and be disposed in the insertion groove 312.

In addition, the piezoelectric element 320 may be expanded and contracted in a length direction of the insertion groove 312. Therefore, during deformation of the piezoelectric element 320, the connecting member 340 may be moved in the length direction of the base member 310 depending on the deformation of the piezoelectric element 320.

The impact transferring member 330 may be installed in the communications groove 314 and contact the display panel 120 or be spaced apart from the display panel 120 during the deformation of the piezoelectric element 320. In other words, the impact transferring member 330 may contact the display panel 120 or may be spaced apart from the display panel 120 by the expansion and contraction of the piezoelectric element 320.

Meanwhile, the impact transferring member 330 may have an inclined surface 332 so as to movable from the communications groove 314. As an example, the impact transferring member 330 may have a triangular transversal cross section.

In addition, the impact transferring member 330 may have a shape corresponding to that of the communications groove 314. Therefore, when the connecting member 340 is moved, the impact transferring member 330 may be disposed to protrude from the communications groove 314 or be inserted into the communications groove 314.

In other words, in the case in which the impact transferring member 330 protrudes from the communications groove 314, an upper surface of the impact transferring member 330 and a lower surface of the display panel 120 may contact each other, and in the case in which the impact transferring member 330 is inserted into the communications groove 314, the impact transferring member 330 may be disposed to be spaced apart from the display panel 120.

The connecting member 340 may have one end connected to the piezoelectric element 320 and the other end contacting the impact transferring member 330 or disposed to be spaced apart from the impact transferring member 330 by a predetermined interval to allow the impact transferring member 330 to be moved along the inclined surface 314a of the communications groove 314 during deformation of the piezoelectric element 320.

In other words, the other end of the connecting member 340 is not fixedly attached to the impact transferring member 330, but may be in a state in which it simply contacts the impact transferring member 330 or is disposed to be spaced apart from the impact transferring member 320 by a predetermined interval in the case in which power is not applied to the piezoelectric element 320.

In addition, in the case in which the power is applied to the piezoelectric element 320, in other words, in the case in which the piezoelectric element 320 is expanded, the connecting member 340 may be moved to press the inclined surface 332 of the impact transferring member 330. Therefore, the impact transferring member 330 is moved along the inclined surface 314a of the communications groove 314, such that the impact transferring member 330 may be disposed to protrude from the communications groove 314.

The elastic member 350 may be attached to the base member 310 so as to close an upper portion of the communications groove 314.

In addition, the elastic member 350 may serve to prevent the impact transferring member 330 from falling to the display panel 120 due to inherent weight of the impact transferring member 330 in the case in which the haptic feedback actuator module 300 is overturn, in other words, in the case in which the display panel 120 is disposed under the haptic feedback actuator module 300.

In addition, in the case in which the impact transferring member 330 is moved by the connecting member 340, the elastic member 350 may have elastic force so that it may be expanded by the impact transferring member 330.

In other words, the elastic member 350 is not deformed due to the inherent weight of the impact transferring member 330, but may be deformed by movement of the impact transferring member 330.

Meanwhile, the elastic member 350 may be formed of a thin film having elasticity.

As described above, the impact transferring member 330 repeatedly contacts the display panel 120 and is spaced apart from the display panel 120 depending on the expansion and contraction of the piezoelectric element 320, whereby the display panel 120 may vibrate.

As a result, the connecting member 340 is moved by deformation of the piezoelectric element 320 such as the expansion and contraction of the piezoelectric element 320 to directly apply impact the display panel 120 through the impact transferring member 330, whereby attenuation of vibrations due to an adhesive formed of epoxy, or the like, may be prevented.

That is, in the case in which the piezoelectric element 320 is attached to the base member 310 by the adhesive, the attenuation of the vibrations due to the adhesive such as epoxy may be generated. However, as described above, the impact by the deformation of the piezoelectric element 320 may be transferred to the display panel 120 without the attenuation of the vibrations through the connecting member 340 and the impact transferring member 330, such that an amount of vibrations may increase.

Hereinafter, an operation of the haptic feedback actuator module according to another embodiment of the present invention will be described with reference to the accompanying drawings.

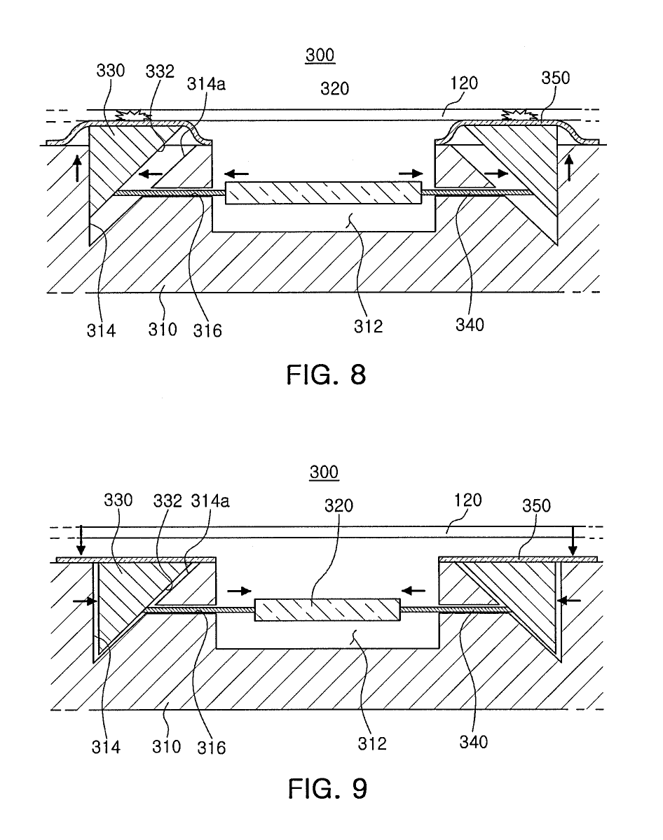

FIGS. 8 and 9 are views for describing an operation of the haptic feedback actuator module according to another embodiment of the present invention.

First, as shown in FIG. 8, when power is supplied to the piezoelectric element 320, the piezoelectric element 320 may be expanded. Therefore, the connecting member 340 having one end portion fixedly attached to the piezoelectric element 320 may be moved in a direction away from a side on which the piezoelectric element 320 is disposed.

In this case, the connecting member 340 may be moved along the connection hole 316 formed in the base member 310.

When the connecting member 340 is moved, the impact transferring member 330 may be pressed by the connecting member 340. Therefore, the impact transferring member 330 may be moved along the inclined surface 314a of the communications groove 314.

Therefore, the impact transferring member 330 may protrude from the communications groove 314. In this case, the elastic member 350 is deformed, such that the impact transferring member 330 and the display panel 120 may contact each other. Therefore, the impact transferring member 330 may apply impacts the display panel 120.

Then, as shown in FIG. 9, when the piezoelectric element 320 is contracted, the connecting member 340 may be moved from a side at which the communicating groove 314 is disposed toward the piezoelectric element 320 and the impact transferring member 330 may be inserted into the communications groove 314 by the elastic member 350.

Therefore, the impact transferring member 330 may be spaced apart from the display panel 120.

As described above, the impact transferring member 330 repeatedly contacts the display panel 120 and is spaced apart from the display panel 120 depending on the expansion and contraction of the piezoelectric element 320, whereby the display panel 120 may vibrate.

In other words, the connecting member 340 is moved by deformation of the piezoelectric element 320 such as the expansion and contraction of the piezoelectric element 320 to directly apply impact the display panel 120 through the impact transferring member 330, whereby attenuation of vibrations due to an adhesive formed of epoxy, or the like, may be prevented.

That is, in the case in which the piezoelectric element 320 is attached to the base member 310 by the adhesive, the attenuation of the vibrations due to the adhesive such as epoxy may be generated. However, as described above, the impact by the deformation of the piezoelectric element 320 may be transferred to the display panel 120 without the attenuation of the vibrations through the connecting member 340 and the impact transferring member 330, such that an amount of vibrations may increase.

Since vibrations may be provided to the display panel through the impact transferring member connected to the piezoelectric element, the vibrations are transferred without attenuation of an amount of vibrations, whereby the vibration amount may increase.

While the present invention has been shown and described in connection with the embodiments, it will be apparent to those skilled in the art that modifications and variations can be made without departing from the spirit and scope of the invention as defined by the appended claims.

What is claimed is:

1. A haptic feedback actuator module comprising:
a base member including an insertion groove formed in an edge thereof and communications grooves formed at both ends of the insertion groove;
a piezoelectric element inserted into the insertion groove;
an impact transferring member installed in the communications groove and contacting a display panel or spaced apart from the display panel during deformation of the piezoelectric element; and
a connecting member having one end connected to the piezoelectric element and the other end connected to the impact transferring member.

2. The haptic feedback actuator module of claim 1, wherein the impact transferring member is rotatably installed on a shaft installed in the communications groove and rotated during the deformation of the piezoelectric element.

3. The haptic feedback actuator module of claim 2, wherein the impact transferring member includes a contact part contacting the display panel or spaced part from the display panel by rotation or an extension part extended from the contact part and connected to the connecting member.

4. The haptic feedback actuator module of claim 1, wherein the base member is provided with a connection hole connecting the insertion groove and the communications groove to each other, and
one end portion of the connecting member is disposed in the communications groove while penetrating through the connection hole.

5. The haptic feedback actuator module of claim 1, further comprising an elastic member stacked on an upper surface of the base member so as to be disposed above the communications groove.

6. The haptic feedback actuator module of claim 5, wherein the impact transferring member and the communicating groove have inclined surfaces so that the impact transferring member is movable during the deformation of the piezoelectric element.

7. The haptic feedback actuator module of claim 6, wherein the connecting member has one end connected to the piezoelectric element and the other end contacting the impact transferring member or disposed to be spaced apart from the impact transferring member by a predetermined interval to allow the impact transferring member to be moved along the inclined surface during deformation of the piezoelectric element.

8. The haptic feedback actuator module of claim 6, wherein the base member is provided with a connection hole connecting the insertion groove and the communications groove to each other, and
one end portion of the connecting member is led to the communications groove while penetrating through the connection hole.

9. The haptic feedback actuator module of claim 6, wherein the connecting member has a degree of strength capable of preventing the piezoelectric element from sagging when driving of the piezoelectric element ends.

10. An electronic device comprising:
a case having an internal space formed therein;
a display panel accommodated and disposed in the case;
a base member installed in the case so as to be spaced apart from the display panel by a predetermined distance and including an insertion groove formed in an edge thereof and communications grooves formed at both ends of the insertion groove;
a piezoelectric element inserted into the insertion groove;
an impact transferring member installed in the communications groove and providing vibrations to the display panel during deformation of the piezoelectric element; and
a connecting member having one end connected to the piezoelectric element and the other end connected to the impact transferring member.
